(19) United States
(12) Patent Application Publication
(10) Pub. No.: US 2011/0262251 A1
(43) Pub. Date: Oct. 27, 2011

(54) WORKPIECE CONVEYING SYSTEM

(75) Inventors: Yasunobu OTOGAWA, Osaka (JP); Haruo MAETANI, Osaka (JP); Kota HOSHIJIMA, Osaka (JP)

(73) Assignee: DAIHEN CORPORATION, Osaka (JP)

(21) Appl. No.: 13/083,976

(22) Filed: Apr. 11, 2011

(30) Foreign Application Priority Data
Apr. 22, 2010 (JP) 2010-098470

(51) Int. Cl. B65G 43/00; B65G 47/90

(52) U.S. Cl. 414/222.02; 414/222.07

(57) ABSTRACT

A workpiece conveying system includes at least three workpiece storage chambers arranged in a predetermined arrangement direction. A conveyance chamber is provided adjacent to the workpiece storage chambers. A workpiece processing chamber is provided adjacent to the conveyance chamber on the side opposite the workpiece storage chambers. First and second workpiece conveying robots are disposed in the conveyance chamber. The workpiece conveying robots are controlled by a controller and convey workpieces between the workpiece processing chamber and the workpiece storage chambers. The first and second workpiece conveying robots are spaced from each other in the arrangement direction. Each workpiece conveying robot conveys a workpiece into and out of at least two of the workpiece storage chambers.

### BACKGROUND OF THE INVENTION

1. Field of the Invention:

The present invention relates to a workpiece conveying system for conveying thin-plate workpieces, such as wafers, during semiconductor manufacture or the like. More specifically, the present invention relates to a workpiece conveying system configured to convey workpieces between -a workpiece processing chamber and workpiece storage chambers, using workpiece conveying robots.

2. Description of Related Art:

Conventionally, conveying robots have been used to convey workpieces, such as wafers, in the field of semiconductor manufacture. Such workpiece conveying robots are configured to convey a workpiece between a workpiece storage chamber, in which wafers, for example, are stored, and a workpiece processing chamber.

FIG. 13 shows an example of a conventional workpiece conveying system (see Japanese Patent Laid-open No. 2003-188231, for example). A workpiece conveying system B shown in FIG. 13 includes two workpiece storage chambers 91, a conveyance chamber 92, a workpiece processing chamber 93, and a workpiece conveying robot 94. The work-piece storage chambers are arranged side by side in a direction X1-X2, each workpiece storage chamber being capable of storing multiple workpieces W. The conveyance chamber 92 is provided adjacent to the workpiece storage chambers 91 and accommodates therein a single workpiece conveying robot 94. The workpiece processing chamber 93 is provided adjacent to the conveyance chamber 92 on the side opposite the workpiece storage chambers 91. In other words, the workpiece processing chamber 93 is spaced from the workpiece storage chambers 91 in a direction Y1-Y2. In the workpiece processing chamber 93, processing such as heat treatment, machining, and inspection is performed on a workpiece W. The workpiece conveying robot 94 conveys a workpiece W into and out of each of the workpiece storage chambers 91 and the workpiece processing chamber 93.

Below, a description is given of an example of workpiece conveyance processing performed in the workpiece conveying system B. First, an unprocessed workpiece W is taken out of one of the two workpiece processing chambers 91 (see FIG. 14) and conveyed into the workpiece processing chamber 93 (see FIG. 15). In the workpiece processing chamber 93, predetermined processing is performed on the workpiece W. Then, the processed workpiece W is taken out of the workpiece processing chamber 93 and conveyed into the other workpiece storage chamber 91.

The workpiece conveying robot 94 is disposed so as to shorten a conveyance path for workpiece conveyance in the conveyance chamber 92. Specifically, the workpiece conveying robot 94 is disposed in a central position between the two workpiece storage chambers 91 in the direction X1-X2 (as a result, the workpiece conveying robot 94 directly faces the workpiece processing chamber 93).

The conveyance chamber 92 includes opposing side walls 92a and 92b. The dimension of the conveyance chamber 92 in the direction Y1-Y2 is set relatively large in order to prevent interference between the workpiece conveying robot 94 and the side walls 92a and 92b. The workpiece conveying robot 94 is spaced a predetermined distance from the side walls 92a and 92b and located in the center of the conveyance chamber 92 in the direction Y1-Y2.

In semiconductor manufacture, improved production efficiency and a reduced footprint (floor space required for a manufacturing device or the like) are generally required. In the aforementioned workpiece conveying system, a shorter workpiece conveyance path shortens the time required for workpiece conveyance and consequently improves production efficiency. However, in the workpiece conveying system B, the dimension of the conveyance chamber 92 in the direction Y1-Y2 is relatively large. Thus, there is still room for improvement in terms of reducing a footprint in the workpiece conveying system B. There is also a problem with the workpiece conveying system B in that, in the case where the workpiece conveying robot 94 becomes inoperable due to a failure or another reason, the function of the workpiece conveying system B stops completely, which results in a reduction in production efficiency.

### SUMMARY OF THE INVENTION

The present invention has been devised in view of the aforementioned circumstances. It is an object of the present invention to provide a workpiece conveying system that is capable of suppressing a reduction in production efficiency while reducing a footprint.

A workpiece conveying system according to a first aspect of the present invention includes at least three workpiece storage chambers arranged in a predetermined arrangement direction, a conveyance chamber adjacent to the workpiece storage chambers, a workpiece processing chamber adjacent to the conveyance chamber on a side opposite the workpiece storage chambers, first and second workpiece conveying robots, disposed in the conveyance chamber and configured to convey a workpiece between the workpiece processing chamber and the workpiece storage chambers, and a controller configured to control the workpiece conveying robots. The first and second workpiece conveying robots are spaced from each other in the arrangement direction. Each of the workpiece conveying robots conveys a workpiece into and out of at least two of the workpiece storage chambers.

According to a preferred embodiment of the present invention, the workpiece conveying system may include four or five workpiece storage chambers. In the former case (where four workpiece storage chambers are included), each of the workpiece conveying robots conveys a workpiece into and out of, for example, two of the workpiece storage chambers. In the latter case (where five workpiece storage chambers are included), each of the workpiece conveying robots conveys a workpiece into and out of, for example, three of the workpiece storage chambers.

Preferably, the first and second workpiece conveying robots are disposed in positions the same distance away from a central position of the workpiece storage chambers in the arrangement direction.

Preferably, each of the workpiece conveying robots includes a fixed base, an elevating base, an elevating mechanism, a first arm, a first-arm drive mechanism, a second arm, a second-arm drive mechanism, a hand, and a hand drive mechanism. The fixed base is fixed to the conveyance chamber. The elevating mechanism is for moving the elevating base up and down with respect to the fixed base. The first arm has a first end and a second end, the first end being supported by the elevating base so as to enable rotation about a first vertical axis. The first-arm drive mechanism is for rotating the first arm about the first vertical axis. The second arm has a first end and a second end, the first end being supported by the second end of the first arm so as to enable rotation about a second vertical axis. The second-arm drive mechanism is for rotating the second arm about the second vertical axis. The hand is supported by the second end of the second arm so as to enable rotation about a third vertical axis. The hand drive mechanism is for rotating the hand about the third vertical axis.

Preferably, each of the workpiece conveying robots is disposed in a position biased in the arrangement direction from a position directly facing the workpiece processing chamber.

Preferably, the controller includes a drive control means, a feature detection means, and a power-application interruption means. The drive control means is for controlling both of the first and second workpiece conveying robots. The failure detection means is for detecting a failure in the first and second workpiece conveying robots. The power-application interruption means is for, in the case where a failure occurs in one of the first and second workpiece conveying robots, interrupting application of power to the failed workpiece conveying robot.

Preferably, the controller further includes a connection detection means and a connection detection disabling means. The connection detection means is for detecting a condition of electrical connection between the drive control means and the first and second workpiece conveying robots. The connection detection disabling means is for disabling the detection performed by the connection detection means with respect to a failed workpiece conveying robot.

The workpiece conveying system according to the present invention includes two workpiece conveying robots, the operations of which are controlled so as to prevent a collision therebetween during workpiece conveyance processing. Accordingly, this workpiece conveying system can achieve a higher throughput, which enables the entire system to run with greater efficiency.

Other features and advantages of the present invention will become apparent from the following detailed description with reference to the accompanying drawings.

### BRIEF DESCRIPTION OF THE DRAWINGS

FIG. 1 is a plan view of a workpiece conveying system according to a first embodiment of the present invention.

FIG. 2 is a side view of a workpiece conveying robot.

FIG. 3 is a block diagram showing an exemplary schematic configuration of a system for controlling workpiece conveying robots.

FIG. 4 is a plan view for describing the operation of the workpiece conveying robot.

FIG. 5 is a plan view for describing the operation of the workpiece conveying robot.

FIG. 6 is a plan view for describing the operation of the workpiece conveying robot.

FIG. 7 is a plan view for describing the operation of the workpiece conveying robot.

FIG. 8 is a plan view for describing the operation of the workpiece conveying robot.

FIGS. 9A to 9E are plan views for describing the procedure of workpiece conveyance performed in the workpiece conveying system of the first embodiment.

FIGS. 10A to 10E are plan views for describing the procedure of workpiece conveyance performed in the workpiece conveying system of the first embodiment.

FIG. 11 is a plan view of a workpiece conveying system according to a second embodiment of the present invention.

FIG. 12 is a plan view of a workpiece conveying system according to a third embodiment of the present invention.

FIG. 13 is a plan view of a conventional workpiece conveying system.

FIG. 14 is a plan view of the conventional workpiece conveying system.

FIG. 15 is a plan view of the conventional workpiece conveying system.

### DETAILED DESCRIPTION OF THE PREFERRED EMBODIMENTS

The following is a detailed description of preferred embodiments of the present invention with reference to the drawings.

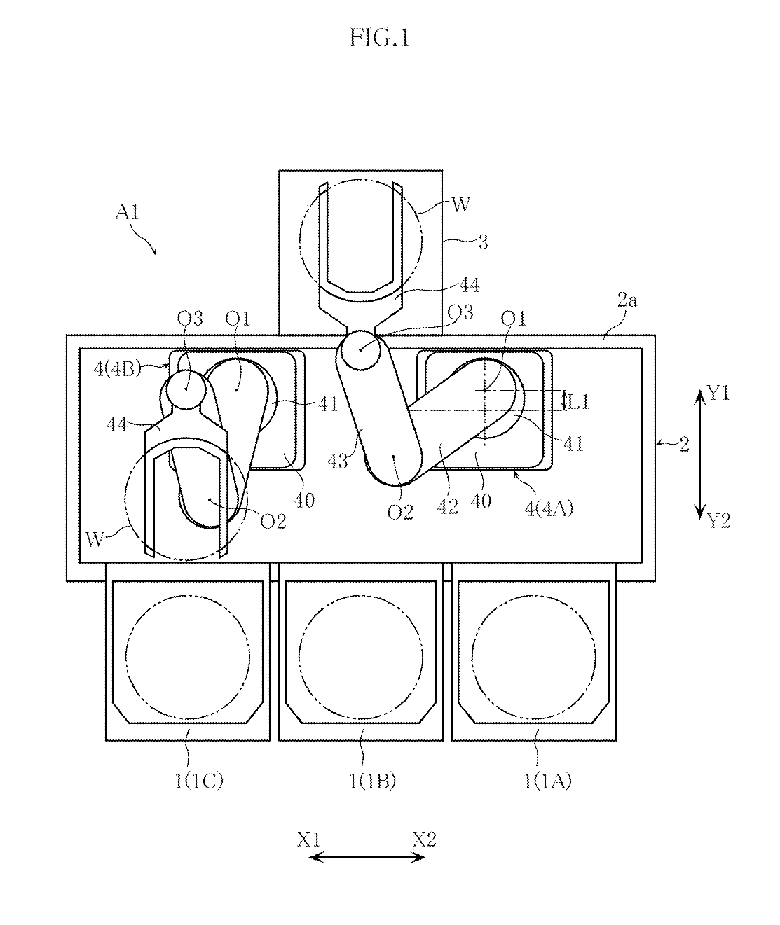

FIG. 1 shows a workpiece conveying system according to a first embodiment of the present invention. A workpiece conveying system A1 of the present embodiment includes three workpiece storage chambers 1 (which may also be referred to “workpiece storage chambers 1A, 1B, and 1C” below), a conveyance chamber 2, a workpiece processing chamber 3, and two conveying robots 4 (which may also be referred to as “conveying robots 4A and 4B” below). The workpiece conveying system A1 further includes a controller (not shown) for controlling the operations of the two conveying robots 4. The workpiece conveying system A1 is configured to convey thin-plate workpieces W such as wafers, for example.

The three workpiece storage chambers 1 are arranged in a straight line at regular pitches, each workpiece storage chamber 1 being configured to be able to accommodate therein a cassette in which multiple workpieces W can be stored.

The conveyance chamber 2 is provided adjacent to the three workpiece storage chambers 1 and has a rectangular parallelepiped shape that extends longitudinally in the direction in which the workpiece storage chambers 1 are arranged (an arrangement direction X1-X2).

The workpiece processing chamber 3 is for performing processing, such as heat treatment, machining, and inspection, on a workpiece W. The workpiece processing chamber 3 is provided adjacent to the conveyance chamber 2 on the side opposite the workpiece storage chambers 1. The workpiece processing chamber 3 is provided at the central position of the workpiece storage chambers 1 in the arrangement direction X1-X2. Note that an open/close shutter may be provided as necessary between the workpiece processing chamber 3 and the conveyance chamber 2.

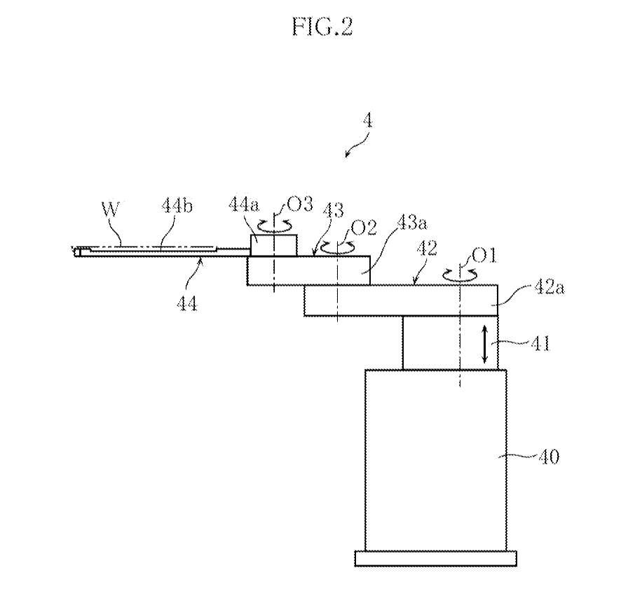

The two conveying robots 4 are configured to convey workpieces W between the workpiece processing chamber 3 and the workpiece storage chambers 1 and, and are disposed inside the conveyance chamber 2. As illustrated in FIG. 2, each conveying robot 4 includes a fixed base 40, an elevating base 41, a lower arm 42, an upper arm 43, and a hand 44. The fixed base 40 is fixed to the lower part (for example, a bottom plate or the like) of the conveyance chamber 2 via a seat.

The elevating base 41 is supported by the fixed base 40 so as to be able to move upward and downward. For example, the following mechanism is considered as an example of a mechanism for moving the elevating base 41 up and down. A single straight-line guide rail, which extends in a vertical direction, is provided inside the fixed base 40 (two or more guide rails may be provided). The guide rail is provided with a slider that is movable in the vertical direction, and this slider is fixed to the elevating base 41. Also, a rotatable screw shaft is provided inside the fixed base 40. The screw shaft is provided with a nut that is in threaded engagement coaxially therewith, and this nut is fixed to the elevating base 41. A servomotor (elevating motor) is provided in the lower part of the fixed base 40, and an output pulley is fixed to an output shaft of the elevating motor. Meanwhile, a pulley is also provided on the screw shaft, and a belt is looped around this pulley and the output pulley. With this configuration, when the elevating motor is driven, the screw shaft is rotated, and the elevating base 41 is moved up or down by the rotation of the screw shaft.

The lower arm 42, which may be hollow and have a rectangular cross section, is supported by the elevating base 41 so as to extend in a horizontal orientation. A root end 42a of the lower arm 42 includes a vertically downward shaft portion (not shown), and the shaft portion is in a state fitted in a hole formed in the upper part of the elevating base 41. The lower arm 42 is thereby rotatable about a vertical axis O1. A lower-arm drive servomotor (lower-arm motor) is provided in the elevating base 41, and an output pulley is provided on an output shaft of the lower-arm motor. Meanwhile, an idler pulley is provided on the shaft portion of the lower arm 42, and a belt is looped around the idler pulley and the output pulley. With this configuration, when the lower-arm motor is driven, the lower arm 42 is rotated about the vertical axis O1. This constitutes a lower-arm drive mechanism for rotating the lower arm 42 about the vertical axis O1. In the present embodiment, the position of the vertical axis O1 is set to a position biased a predetermined distance L1 from the central axis of the fixed base 40.

The upper arm 43, which may be hollow and have a rectangular cross section, is supported by the lower arm 42 so as to extend in a horizontal orientation. A root end 43a of the upper arm 43 includes a vertically downward shaft portion (not shown), and the shaft portion is in a state fitted in a hole formed in the upper part of one end of the lower arm 42.

The upper arm 43 is thereby rotatable about a vertical axis O2. An upper-arm drive servomotor (upper-arm motor) is provided in the elevating base 41. Meanwhile, an upper-arm relay shaft is provided, which is rotatable relative to the shaft portion of the lower arm 42. An output pulley is provided on an output shaft of the upper-arm motor, and a lower-end relay pulley is provided on the lower end of the upper-arm relay shaft. Then, a belt is looped around the output pulley and the low-end relay pulley. Also, a upper-end relay pulley is provided on the upper end of the upper-arm relay shaft, and an idler pulley is provided on the shaft portion of the upper arm 43. Then, a belt is looped around the upper-end relay pulley and the idler pulley. With this configuration, when the upper-arm motor is driven, the upper arm 43 is rotated about the vertical axis O2. This constitutes an upper-arm drive mechanism for rotating the upper arm 43 about the vertical axis O2.

A hand 44 has a two-pronged fork shape and is supported by the upper arm 43 in an axially horizontal orientation. As illustrated in FIG. 2, the hand 44 has a recessed portion 44b formed therein for placing and holding a circular workpiece W of a predetermined size. A root end 44a of the hand 44 includes a vertically downward shaft portion (not shown), and the shaft portion is in a state fitted in a hole formed in the upper part of one end of the upper arm 43. The hand 44 is thereby rotatable about the vertical axis O3. Also, a hand drive servomotor (hand motor) is provided in the elevating base 41. A first relay shaft that is rotatable relative to the shaft portion of the lower arm 42 is provided, and a second relay shaft that is rotatable relative to the shaft portion of the upper arm 43 is provided. An output pulley is provided on an output shaft of the hand motor, and a first lower-end relay pulley is provided on the lower end of the first relay shaft. Then, a belt is looped around the output pulley and the first lower-end relay pulley. A first upper-end relay pulley is provided on the upper end of the first relay shaft, and a second lower-end relay pulley is provided on the lower end of the second relay shaft. Then, a belt is looped around the first upper-end relay pulley and the second lower-end relay pulley. A second upper-end relay pulley is provided on the upper end of the second relay shaft, and an idler pulley is provided on the shaft portion of the hand 44. Then, a belt is looped around the second upper-end relay pulley and the idler pulley. With this configuration, when the hand motor is driven, the hand 44 is rotated about the vertical axis O3. This constitutes a hand drive mechanism for rotating the hand 44 about the vertical axis O3.

Although detailed descriptions of the structures for supporting the elevating base 41, the arms 42 and 43, and the hand 44 as well as the elevating mechanism, the arm drive mechanisms, and the hand drive mechanism with reference to the drawings have been omitted, those structures and mechanisms can be achieved by configurations similar to those disclosed in Japanese Patent Laid-open No. 2003-188231. Note that although the above embodiment describes a case where the elevating base 41 includes the drive motors provided respectively as the arm drive mechanisms and the hand drive mechanism so as to rotate the arms 42 and 43 and the hand 44 through the linkage of the pulleys, the relay shafts, and the belts, the shaft portions of the arms 42 and 43 and the hand 44 may be directly connected to the output shaft of a drive motor.

Note that a seal member may be interposed as necessary between the fixed base 40 and the elevating base 41, between the elevating base 41 and the lower arm 42, between the lower arm 42 and the upper arm 43, and between the upper arm 43 and the hand 44. This provides hermetical sealing of the internal space of the conveying robot 4 against the outside, thus preventing fine dust or dirt in the conveying robot 4 from dispersing into the conveyance chamber 2.

As illustrated in FIG. 1, the two conveying robots 4 are spaced from each other to the extent that interference therebetween during workpiece conveyance can be prevented. Specifically, the two conveying robots 4 are disposed in, for example, positions the same (or substantially the same) distance away from the central position of the three workpiece storage chambers 1 (as viewed in the arrangement direction X1-X2). The term “distance” as used herein refers to the length from the central position to the vertical axis O1 of each robot 4 (that is, the length as viewed in the arrangement direction X1-X2). In the present embodiment, the conveying robots 4A and 4B are disposed in positions biased in the arrangement direction X1-X2 from the position directly facing the workpiece processing chamber 3, and are close to a side wall 2a (the side wall facing the workpiece processing chamber 3) of the conveyance chamber 2. Furthermore, the two conveying robots 4A and 4B are disposed in positions shifted toward the center in the arrangement direction X1-X2 from the positions directly facing the right workpiece storage chamber 1A and the left workpiece storage chamber 1C.

Each conveying robot 4 is attached to the conveyance chamber 2 via a jig that enables the position of the conveying robot 4 to be adjusted precisely. Accordingly, even after the conveying robots 4 have been installed once, the positions of the conveying robots 4 can be easily adjusted. Of course, the present invention is not intended to be limited to this, and the conveying robots 4 may be semipermanently fixed to the conveyance chamber 2 by, for example, tightening bolts.

Alternatively, a detachable fixing means (for example, a tightening means configured to establish or cancel fixation through lever operations) may be used to fix the conveying robots 4 to the conveyance chamber 2.

A connector (not shown) for supplying power or transmitting control signals to the motors is provided on a side face of the fixed base 40. The connector is provided in, for example, a place toward the bottom on the side face.

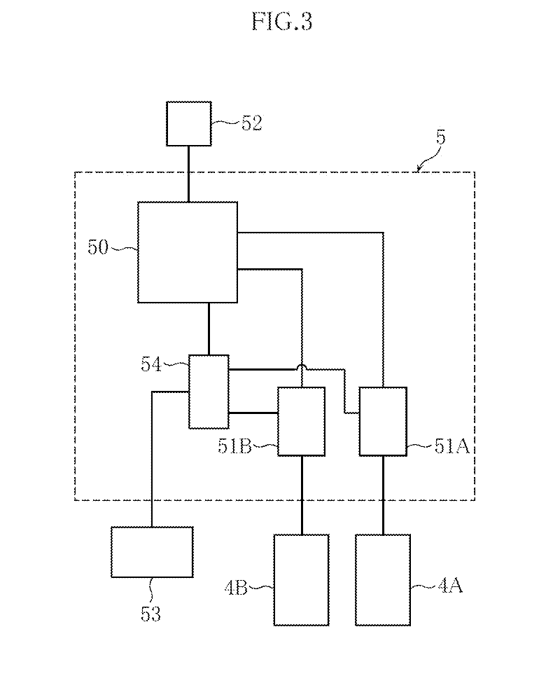

FIG. 3 is a block diagram showing an exemplary configuration of a system for controlling the conveying robots. As shown in FIG. 3, the two conveying robots 4A and 4B are connected to a controller 5. The controller 5 includes a main control unit 50, and servo control units 51A and 51B configured to control the servomotors provided respectively in the conveying robots 4A and 4B.

The main control unit 50 includes, for example, a CPU that executes a program for controlling the robots or the like and performs arithmetic processing. The main control unit 50 further includes, for example, a ROM in which various types of programs, settings data and the like are stored, and a RAM used for temporary storage of data or the like. The CPU, the ROM, the RAM, and so on are connected via a bus line. The main control unit 50 is connected to a teach pendant 52 for performing a teaching task or manual operations (for example, adjustment of the origin and manual input operations) on the conveying robots 4A and 4B.

The main control unit 50 is connected to the servo control units 51A and 51B, and the servo control units 51A and 51B are connected respectively to the conveying robots 4A and 4B. The servo control units 51A and 51B control the drive of the servomotors provided respectively in the conveying robots 4A and 4B and receive position information regarding the shaft of each servomotor as a feedback signal from an encoder. The main control unit 50 also monitors the conditions of electrical connection with the conveying robots 4A and 4B and, when the electrical connection with either (or both) of the conveying robots 4A and 4B is disconnected, detects the disconnection as connection trouble. Note that the servo control units 51A and 51B are connected to a power supply device 53, and drive current from the power supply device 53 is supplied to the servomotors of the conveying robots 4A and 4B via the servo control units 51A and 51B.

A switching device 54 is provided between the power supply device 53 and the servo control units 51A and 51B. The switching device 54 is connected to the main control unit 50. For example, when a signal beyond preset normal limits, which indicates the drive conditions of the servomotors, is received from either of the conveying robots 4A and 4B, the main control unit 50 determines that the conveying robot is suffering a failure, and controls the switching device 54 such that the application of power from the power supply device 53 to that conveying robot is interrupted. In addition, upon detection of a failure of either of the conveying robots, the main control unit 50 disables detection of the condition of electrical connection with that conveying robot. In this way, in the present embodiment, the controller 5 (main control unit 50) controls the drive of the two conveying robots 4A and 4B.

In each conveying robot 4, independent drive control of the lower-arm motor, the upper-arm motor, and the hand motor is possible, and the lower arm 42, the upper arm 43, and the hand 44 can be rotated about the vertical axes O1, O2, and O3, respectively. Accordingly, the hand 44 can be moved to the desired position by appropriately controlling the rotation of the lower arm 42, the upper arm 43, and the hand 44. Furthermore, rotation of the elevating motor in one direction enables the elevating base 41 to move upward, whereas rotation of the elevating motor in the other direction enables the elevating base 41 to move downward. Accordingly, the hand 44 can be moved up and down to the desired height within a predetermined range.

In the present embodiment, the right conveying robot 4A in FIG. 1 conveys a workpiece W into and out of the two, right and central workpiece storage chambers 1A and 1B, and the left conveying robot 4B conveys a workpiece W into and out of the two, left and central workpiece storage chambers 1C and 1B.

FIGS. 4 to 8 show a change of state in the case where the right conveying robot 4A conveys a workpiece W into and out of the workpiece storage chambers 1A and 1B and the workpiece processing chamber 3. FIG. 4 shows a state in which the hand 44 is located in front of the workpiece storage chamber 1A.

FIG. 5 shows a state in which the hand 44 has entered the workpiece storage chamber 1A. In this state, transfer of a workpiece W is performed. Specifically, in the case where a workpiece W has already been placed on the hand 44, that workpiece W is transferred from the hand 44 to the workpiece storage chamber 1A, whereas in the case where no workpiece W has been placed on the hand 44, a workpiece W stored in the workpiece storage chamber 1A is placed on the hand 44. The hand 44 is linearly moved while staying in the same orientation from the state shown in FIG. 4 to the state shown in FIG. 5.

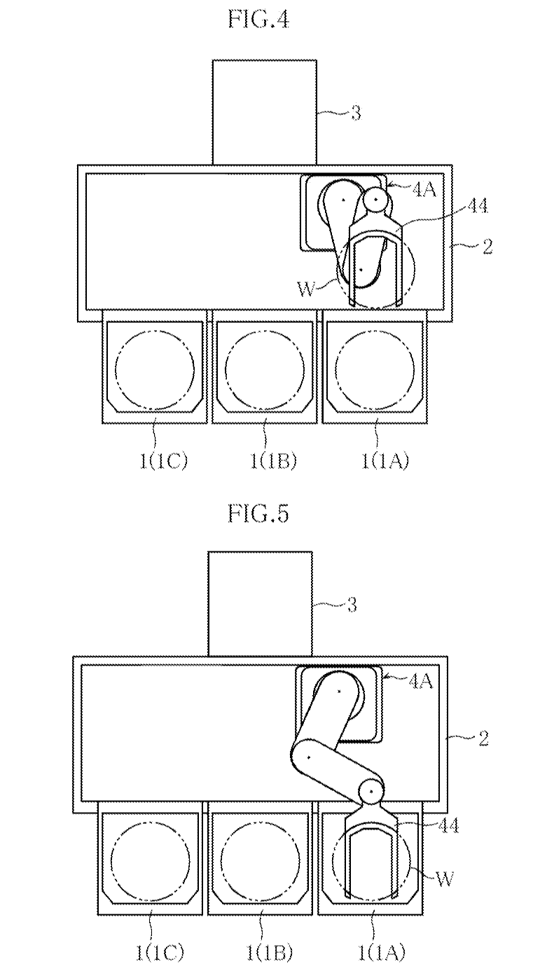

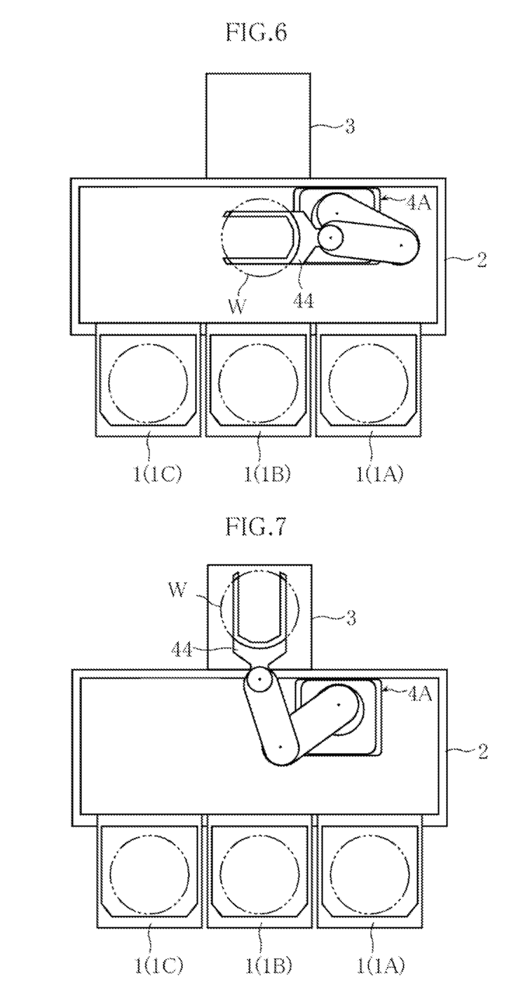

FIG. 6 shows a state in which the hand 44 is located in front of the workpiece processing chamber 3. The hand 44 rotates 90 degrees clockwise in plan view in order to move from the state shown in FIG. 4 to the state shown in FIG. 6.

FIG. 7 shows a state in which the hand 44 has entered the workpiece processing chamber 3 and is transferring the workpiece W. The hand 44 is linearly moved while rotating 90 degrees clockwise in order to move from the state shown in FIG. 6 to the state shown in FIG. 7. Here, the conveying robot 4A is disposed in a position biased toward the right in the arrangement direction X1-X2 from the position directly facing the workpiece processing chamber 3. Accordingly, the conveying robot 4A and the side wall 2a of the conveyance chamber 2 (see FIG. 1) will not interfere with each other even if the conveying robot 4A is close to the side wall 2a.

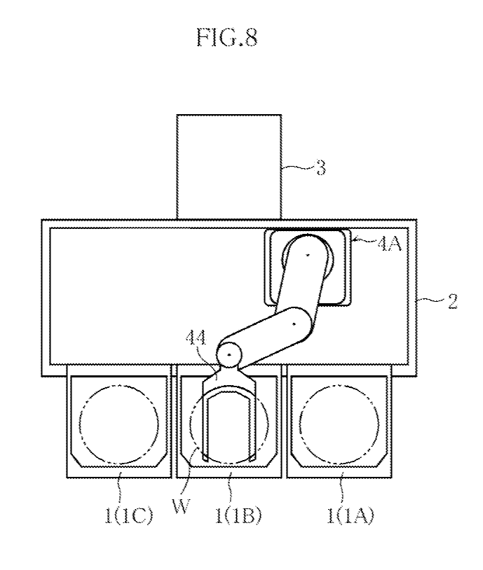

FIG. 8 shows a state in which the hand 44 has entered the workpiece storage chamber 1B and is transferring the workpiece W. The hand 44 is linearly moved while rotating 90 degrees counterclockwise in order to move from the state shown in FIG. 6 to the state shown in FIG. 8.

Note that the transfer of workpieces W in the workpiece storage chambers 1A and 1B and the workpiece processing chamber 3 is accomplished by appropriately moving the elevating base 41 up or down and thereby moving the hand 44 upward or downward.

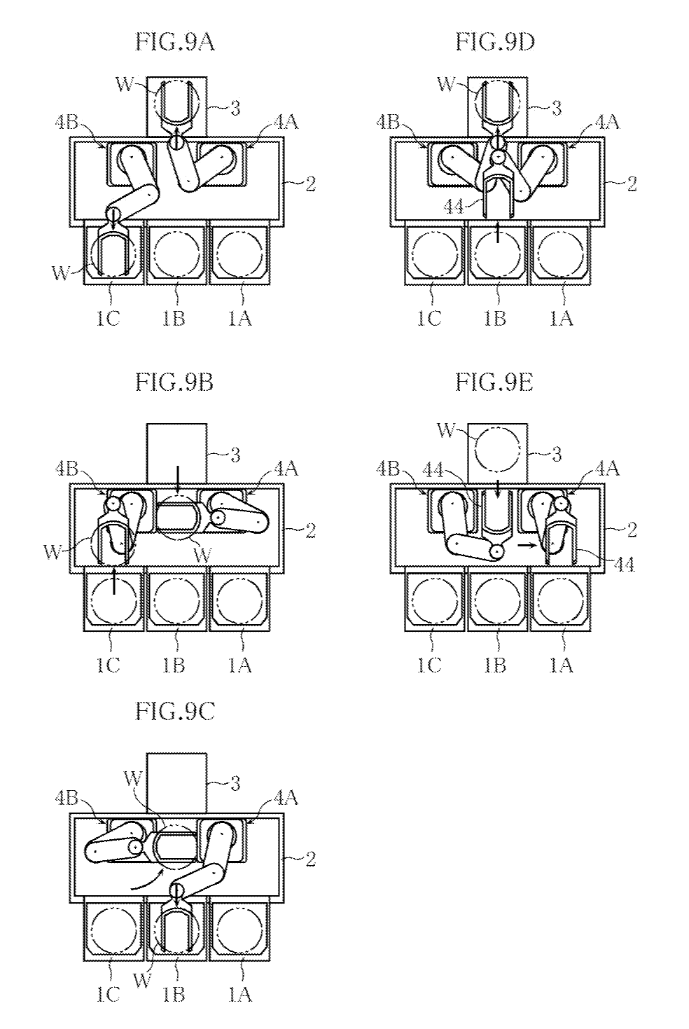

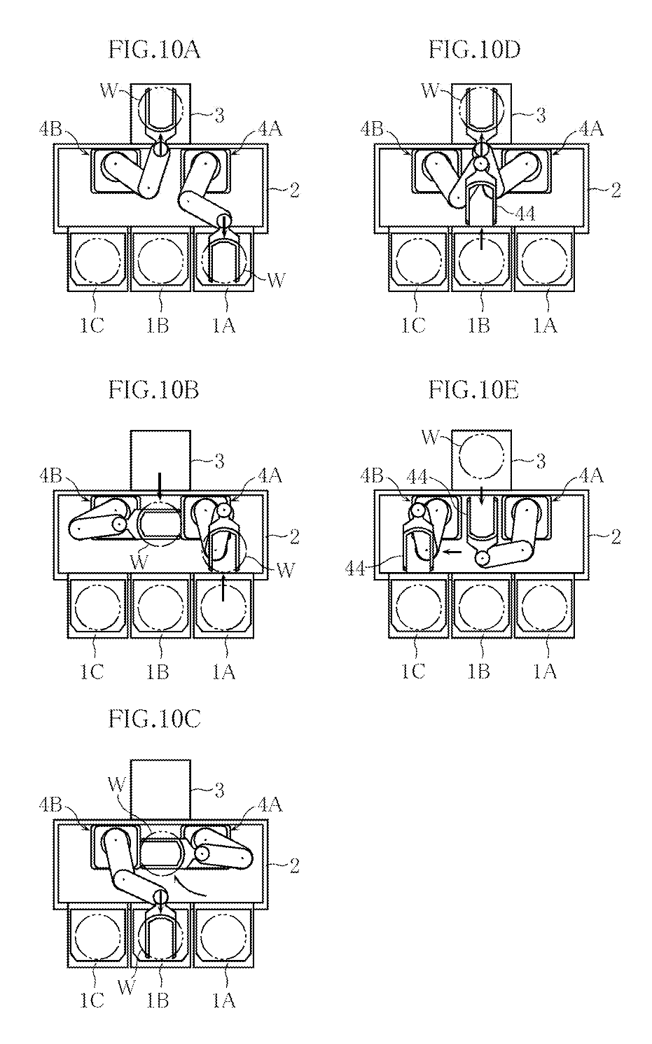

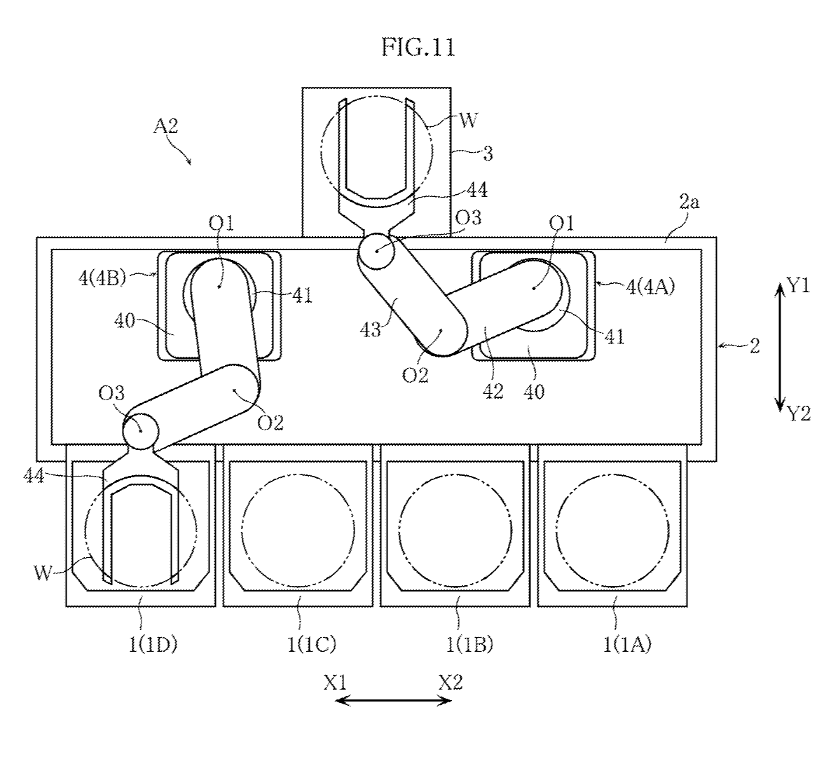

In the present embodiment, the lower arm 42, the upper arm 43, and the hand 44 are rotatable independent of one another. This enables various movements of the hand 44 as described above with reference to FIGS. 4 to 8. Next is a description of an example of the procedure for the operation of conveying a workpiece W, performed by the two conveying robots 4A and 4B in the workpiece conveying system A1, with reference to FIGS. 9 and 10.

In the examples shown in FIGS. 9 and 10, the right workpiece storage chamber 1A and the left workpiece storage chamber 1C are each configured to store multiple unprocessed workpieces W. The workpieces W stored in the workpiece storage chambers 1A and 1C are conveyed one by one to the workpiece processing chamber 3. The central workpiece storage chamber 1B is configured to store processed workpieces W. In other words, a workpiece W processed in the workpiece processing chamber 3 is conveyed into the workpiece storage chamber 1B.

FIG. 9A shows a step in which the right conveying robot 4A receives a processed workpiece W in the workpiece processing chamber 3, and the left conveying robot 4B receives an unprocessed workpiece W in the left workpiece storage chamber 1C.

FIG. 9B shows a step in which the right conveying robot 4A conveys the processed workpiece W out of the workpiece processing chamber 3, and the left conveying robot 4B conveys the unprocessed workpiece W out of the workpiece storage chamber 1C.

FIG. 9C shows a step in which the right conveying robot 4A conveys the processed workpiece W into the central workpiece storage chamber 1B, and the left conveying robot 4B moves the unprocessed workpiece W in front of the workpiece processing chamber 3. Here, the arms 42 and 43 and the hand 44 of the robots 4A and 4B are controlled so as to be at different heights, in order to prevent a collision between the conveying robots 4A and 4B. Such control for preventing a collision between the conveying robots 4A and 4B is also performed in the steps shown in FIG. 9D and FIGS. 10C and 10D.

FIG. 9D shows a step in which the hand 44 of the right conveying robot 4A is retracted from the central workpiece storage chamber 1B, and the left conveying robot 4B conveys the workpiece W into the workpiece processing chamber 3.

FIG. 9E shows a step in which the hand 44 of the right conveying robot 4A is moved in front of the right workpiece storage chamber 4A, and the hand 44 of the left conveying robot 4B is retracted from the workpiece processing chamber 3. In the workpiece processing chamber 3, predetermined processing is performed on the workpiece W conveyed therein.

The operations performed in the steps shown in FIGS. 10A to 10E are symmetrical to the aforementioned operations performed in the steps shown in FIGS. 9A to 9E. In other words, the right conveying robot 4A performs the same operations as those performed by the left conveying robot 4B in FIGS. 9A to 9E, and the left conveying robot 4B performs the same operations as those performed by the right conveying robot 4A in the steps shown in FIGS. 9A to 9E. Detailed descriptions of the operations performed in the steps shown in FIGS. 10A to 10E have been omitted herein, because they will be easily understandable from the above descriptions with reference to FIGS. 9A to 9E.

The two conveying robots 4A and 4B repeatedly perform the operations shown in FIGS. 9A to 9E and FIGS. 10A to 10E. In this way, the right conveying robot 4A conveys workpieces W between the workpiece processing chamber 3 and the workpiece storage chambers 1A and 1B, whereas the left conveying robot 4B conveys workpieces W between the workpiece processing chamber 3 and the workpiece storage chambers 1B and 1C. In other words, the two conveying robots 4A and 4B are controlled so as to perform the processing for conveying a workpiece W in parallel without interfering with each other.

In the above embodiment, although the configuration is such that unprocessed workpieces W are stored in the right workpiece storage chamber 1A and the left workpiece storage chamber 1C, and processed workpieces W are stored in the central workpiece storage chamber 1B, the present invention is not intended to be limited thereto. In addition, the specific procedure of the operations performed by the conveying robots 4A and 4B is not intended to be limited to the above examples described with reference to FIGS. 9A to 9E and FIGS. 10A to 10E.

In the workpiece conveying system A1, the processing for conveying a workpiece W can be performed through the two systems using the two conveying robots 4A and 4B. Accordingly, the workpiece conveying system A1 can achieve a higher throughput, which enables the entire system to run with greater efficiency.

Furthermore, in the workpiece conveying system A1, a work load placed on each conveying robot 4 is lower than in the case where the system includes only a single robot, because the conveyance of workpieces W is carried out by the two conveying robots 4A and 4B. This prolongs the mean time between failures (MTBF) for each conveying robot 4, and as a result, the entire system can run with greater efficiency.

The two conveying robots 4A and 4B are disposed in positions the same distance away from the central position of the workpiece storage chambers 1 in the arrangement direction X1-X2. This allows the conveying robots 4A and 4B to perform bilaterally symmetrical operations, thus making it relatively easy to control the conveying robots 4A and 4B.

The conveying robots 4A and 4B are disposed in positions biased in the arrangement direction X1-X2 from the position directly facing the workpiece processing chamber 3. Accordingly, the conveying robots 4A and 4B can be disposed close to the sidewall 2a of the conveyance chamber 2 without interfering with the side wall 2a. This reduces the dimension in the direction Y1-Y2 (see FIG. 1) at which each workpiece storage chamber 1 and the workpiece processing chamber 3 are spaced from each other, thus reducing a footprint (floor space required for the workpiece conveying system A1).

In the workpiece conveying system A1, the single controller 5 performs overall control of the two conveying robots 4A and 4B. Accordingly, information regarding movements and positions of the movable parts of the two conveying robots 4A and 4B can be grasped properly (without a time lag, for example). This enables the conveying robots 4A and 4B to be controlled while avoiding a collision therebetween, while disposing them close to each other. By disposing the conveying robots 4A and 4B close to each other, it is possible to shorten the workpiece conveyance path. A shorter workpiece conveyance path is suitable for the entire system to run with greater efficiency.

Furthermore, in the workpiece conveying system A1, in the case where one of the conveying robots 4 does not operate properly due to a failure or another reason, the application of power to that conveying robot 4 is interrupted. This prevents the failed conveying robot 4 from running out of control. In addition, the entire system does not stop running because the other conveying robot 4 can continue the processing for conveying a workpiece W. The system further disables detection of the condition of electrical connection with the failed conveying robot 4. Accordingly, it is possible to, for example, replace or repair the failed conveying robot 4 while continuing the processing for conveying a workpiece W, using the other conveying robot 4.

Each conveying robot 4 is fixed to the conveyance chamber 2 in a state that enables its position to be adjusted precisely. Accordingly, if at the time of replacing a failed conveying robot, a replacement conveying robot 4 is positioned in consideration of its individual difference (design errors or the like), the new robot can be fixed in the same position as the failed robot. Accordingly, re-teaching is unnecessary after the replacement of the robot. This is preferable in order to shorten the mean time to repair (MTTR) at the time of a failure in a robot. A shorter MTTR contributes to improving the efficiency of the operation of the entire system. Furthermore, if a means that enables fixation through simple lever operations is employed for the fixation of the conveying robots 4 to the conveyance chamber 2, the MTTR can be more reduced than in the case where the fixation is established by tightening bolts.

FIG. 11 shows a workpiece conveying system according to a second embodiment of the present invention. A workpiece conveying system A2 of the present embodiment is different from the workpiece conveying system A1 of the above-described first embodiment in that it includes four workpiece storage chambers 1. In the workpiece conveying system A2, a right conveying robot 4A (or its vertical axis O1) is disposed in the central position between workpiece storage chambers 1A and 1B in the arrangement direction X1-X2 of the workpiece storage chambers 1, and a left conveying robot 4B (or its vertical axis O1) is disposed in the central position between workpiece storage chambers 1C and 1D in the arrangement direction X1-X2. The right conveying robot 4A conveys workpieces W between the workpiece processing chamber 3 and the two workpiece storage chambers 1A and 1B, and the left conveying robot 4B conveys workpieces W between the workpiece processing chamber 3 and the two workpiece storage chambers 1C and 1D.

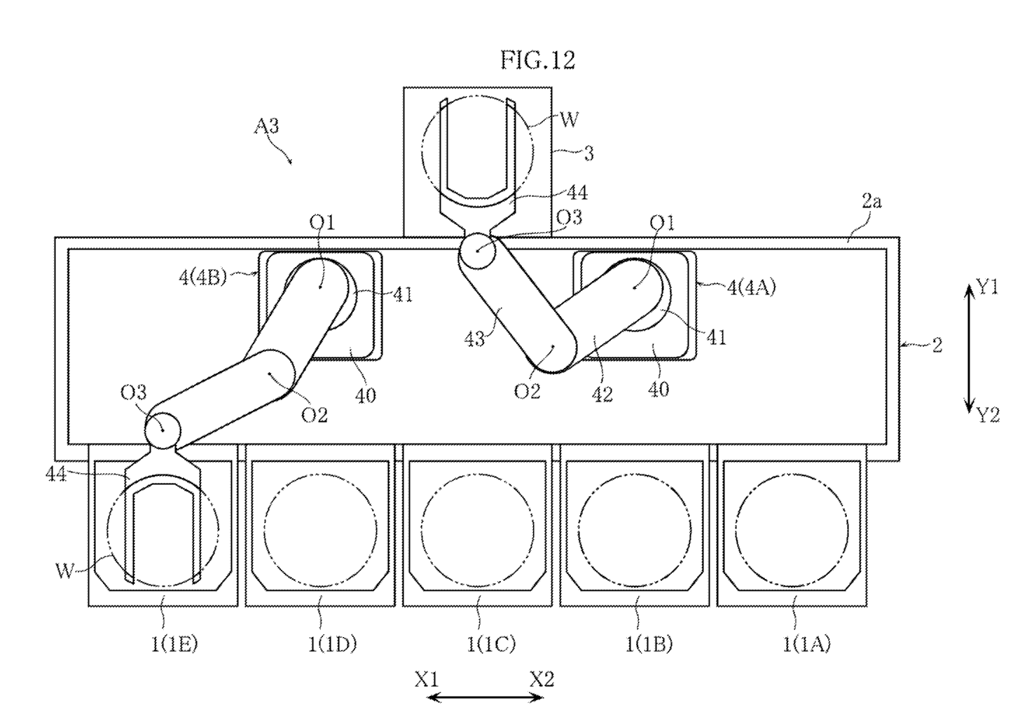

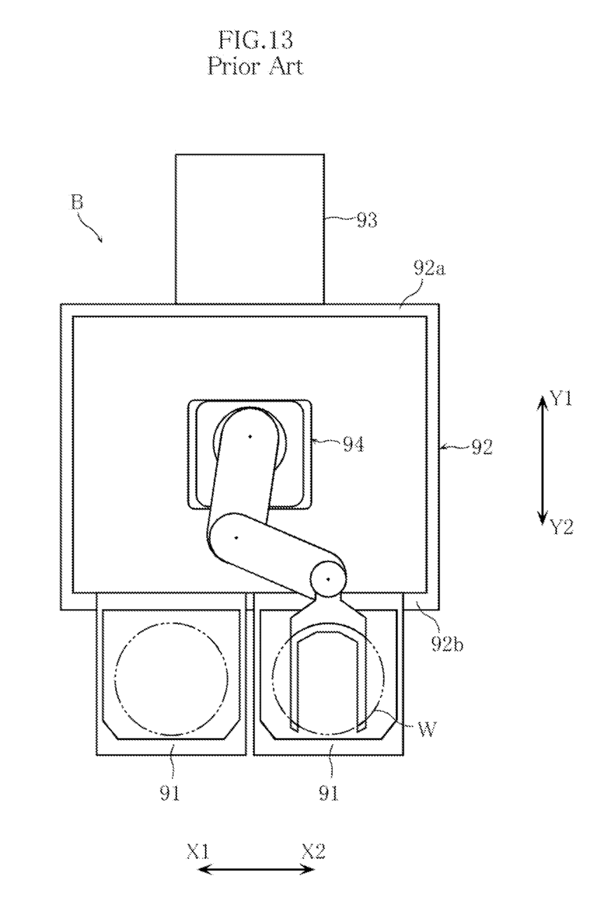

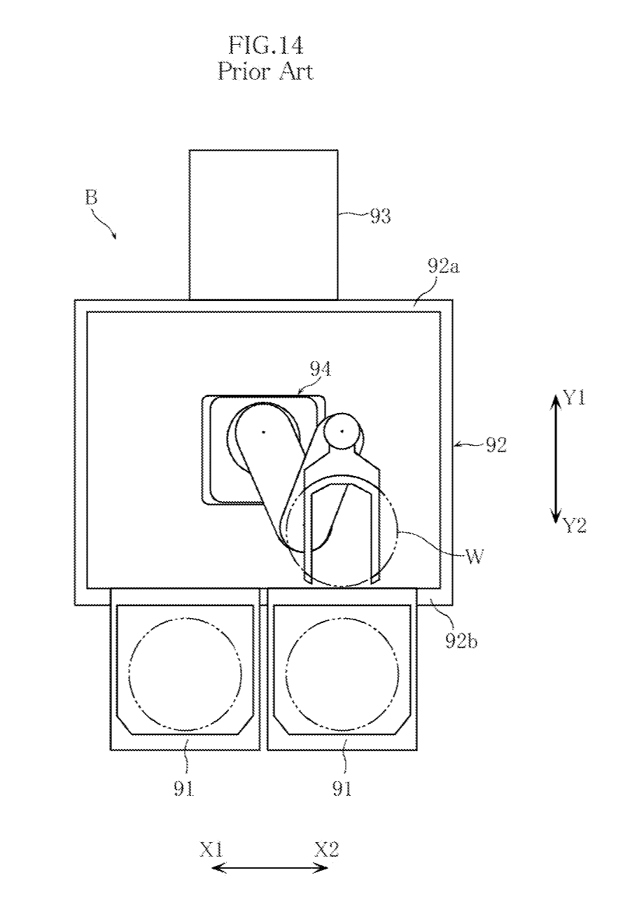

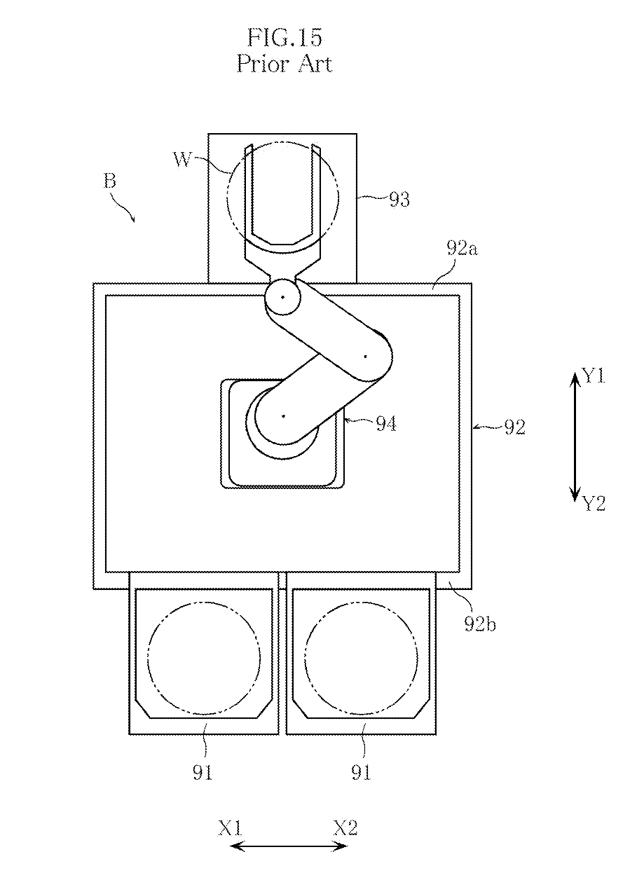

FIG. 12 shows a workpiece conveying system according to a third embodiment of the present invention. A workpiece conveying system A3 of the present embodiment is different from the workpiece conveying system A1 of the above-described first embodiment in that it includes five workpiece storage chambers 1. In the workpiece conveying system A3, a right conveying robot 4A (or its vertical axis O1) is disposed in a position directly facing the workpiece storage chamber 1B, which is the second from the right, and a left conveying robot 4B (or its vertical axis O1) is disposed in a position directly facing the workpiece storage chamber 1D, which is the second from the left. The right conveying robot 4A conveys workpieces W between the workpiece processing chamber 3 and the three workpiece storage chambers 1A, 1B, and 1C, and the left conveying robot 4B conveys workpieces W between the workpiece processing chamber 3 and the three workpiece storage chambers 1C, 1D, and 1E.

In the workpiece conveying systems A2 and A3, the total number of workpiece storage chambers 1 and the relationship of the workpiece storage chambers 1 accessible by each of the conveying robots 4A and 4B are different from those in the workpiece conveying system A1 of the above-described embodiment, but the other components are the same as those of the workpiece conveying system A1. Accordingly, the workpiece conveying systems A2 and A3 can also have the same advantages as described above regarding the workpiece conveying system A1.

Although the foregoing has been a description of embodiments of the present invention, the technical scope of the present invention is not intended to be limited to the above-described embodiments. The specific configurations of the various units of the workpiece conveying systems according to the present invention can be modified in various ways within a scope that does not depart from the concept of the present invention.

1. A workpiece conveying system comprising:
at least three workpiece storage chambers arranged in a predetermined arrangement direction;
a conveyance chamber adjacent to the workpiece storage chambers;
a workpiece processing chamber adjacent to the conveyance chamber on a side opposite the workpiece storage chambers;
first and second workpiece conveying robots, disposed in the conveyance chamber and configured to convey a workpiece between the workpiece processing chamber and the workpiece storage chambers; and
a controller configured to control the workpiece conveying robots,
wherein the first and second workpiece conveying robots are spaced from each other in the arrangement direction, and
each of the workpiece conveying robots conveys a workpiece into and out of at least two of the workpiece storage chambers.

2. The workpiece conveying system according to claim 1, wherein the first and second workpiece conveying robots are disposed in positions the same distance away from a central position of the workpiece storage chambers in the arrangement direction.

3. The workpiece conveying system according to claim 1, wherein each of the workpiece conveying robots includes:
a fixed base fixed to the conveyance chamber;
an elevating base;
an elevating mechanism for moving the elevating base up and down with respect to the fixed base;
a first arm having a first end and a second end, the first end being supported by the elevating base so as to enable rotation about a first vertical axis;
a first-arm drive mechanism for rotating the first arm about the first vertical axis;
a second arm having a first end and a second end, the first end being supported by the second end of the first arm so as to enable rotation about a second vertical axis;
a second-arm drive mechanism for rotating the second arm about the second vertical axis;
a hand supported by the second end of the second arm so as to enable rotation about a third vertical axis; and
a hand drive mechanism for rotating the hand about the third vertical axis.

4. The workpiece conveying system according to claim 1, wherein each of the workpiece conveying robots is disposed in a position biased in the arrangement direction from a position directly facing the workpiece processing chamber.

5. The workpiece conveying system according to claim 1, wherein the controller includes:
a drive control means for controlling both of the first and second workpiece conveying robots;
a failure detection means for detecting a failure in the first and second workpiece conveying robots; and
a power-application interruption means for, in the case where a failure occurs in one of the first and second workpiece conveying robots, interrupting application of power to the failed workpiece conveying robot.

6. The workpiece conveying system according to claim 5, wherein the controller further includes:
a connection detection means for detecting a condition of electrical connection between the drive control means and the first and second workpiece conveying robots; and;
a connection detection disabling means for disabling the detection performed by the connection detection means with respect to a failed workpiece conveying robot.

7. The workpiece conveying system according to claim 1, wherein four workpiece storage chambers are included as the workpiece storage chambers.

8. The workpiece conveying system according to claim 1, wherein five workpiece storage chambers are included as the workpiece storage chambers.

9. The workpiece conveying system according to claim 8, wherein each of the workpiece conveying robots conveys a workpiece into and out of three of the five workpiece storage chambers.
